(19) United States
(12) Patent Application Publication
(10) Pub. No.: US 2026/0274109 A1
(43) Pub. Date: Sep. 17, 2026

(54) BATTERY CONTROL SYSTEM FOR ELECTRIC VEHICLE

(71) Applicant: Prime Planet Energy & Solutions, Inc., Tokyo (JP)

(72) Inventors: Satoru KURANARI, Kakogawa-shi (JP); Kimihiko FURUKAWA, Kakogawa-shi (JP)

(21) Appl. No.: 19/560,146

(22) Filed: Mar. 9, 2026

(30) Foreign Application Priority Data
Mar. 12, 2025 (JP) 2025-039653

(51) Int. Cl. B60L 58/12; H01M 10/42

(52) U.S. Cl. CPC B60L 58/12; H01M 10/425; H01M 2010/4271; H01M 2220/20

(57) ABSTRACT

A battery control system of an electric vehicle includes: a controller that controls a battery of the electric vehicle; and a first monitor that transmits, to the controller, a message instructing the controller to return a computation result for an input. The controller returns, to the first monitor, the computation result for the input. The first monitor determines whether the computation result returned from the controller is correct or not.

### CROSS-REFERENCE TO RELATED APPLICATIONS

The present application claims priority from Japanese Patent No. 2025-039653 filed on Mar. 12, 2025, which is incorporated by reference herein in its entirety.

### BACKGROUND

The present disclosure relates to a battery control system for an electric vehicle.

Japanese Patent Application Publication No. 2004-215366, for example, discloses a battery controller including a battery that supplies electric power to a driving motor of a hybrid car, a main relay that supplies electric power from the battery to the driving motor, and a battery ECU that manages the battery. The battery ECU disclosed in Japanese Patent Application Publication No. 2004-215366 includes a microcomputer that computes a remaining capacity of the battery and communicates with a vehicle ECU, a runaway monitor circuit that monitors runaway of the microcomputer, a timer circuit that time-controls an output signal from the runaway monitor circuit, and a relay control circuit that controls an on/off state of the main relay. When the runaway monitor circuit detects runaway of the microcomputer, the runaway monitor circuit outputs a signal to the timer circuit. The timer circuit outputs the signal input from the runaway monitor circuit with a delay of a set time, and switches the relay from on to off. Japanese Patent Application Publication No. 2004-215366 describes that it is possible to prevent the traveling state of the hybrid car from changing suddenly by the control of delaying the turning off of the relay.

The runaway monitor circuit disclosed in Japanese Patent Application Publication No. 2004-215366 detects runaway of the microcomputer by detecting that a pulse of a specific frequency output from the microcomputer when the microcomputer operates normally is not detected anymore or by detecting that a response signal is not output even when a specific signal is input to the microcomputer.

### SUMMARY

Even if the microcomputer outputs a pulse or returns a response signal, the microcomputer might be in an abnormal state in another mode. Here, an electric vehicle battery control system capable of more reliably detecting abnormality of a controller that controls a battery of an electric vehicle is proposed.

A battery control system for an electric vehicle disclosed herein includes: a controller that controls a battery of the electric vehicle; and a first monitor that transmits, to the controller, a message instructing the controller to return a computation result for an input. The controller returns, to the first monitor, the computation result for the input. The first monitor determines whether the returned computation result is correct or not.

The battery control system can detect that the controller is in an abnormal state based on the fact that the computation result returned to the first monitor from the controller that controls the battery of the electric vehicle is incorrect. Accordingly, the battery control system can more reliably detect abnormality of the controller.

### BRIEF DESCRIPTION OF THE DRAWINGS

FIG. 1 is a block diagram of a battery control system according to one preferred embodiment.

FIG. 2 is a flowchart showing a monitoring flow of a main microcomputer by a sub-microcomputer.

FIG. 3 is a block diagram of a battery control system according to another preferred embodiment.

### DETAILED DESCRIPTION

One preferred embodiment of a battery control system for an electric vehicle will be described hereinafter. The preferred embodiment described here is, of course, not intended to particularly limit the present disclosure. Each drawing is a schematic view and does not necessarily strictly reflect an actual product.

### Configuration of Battery Control System

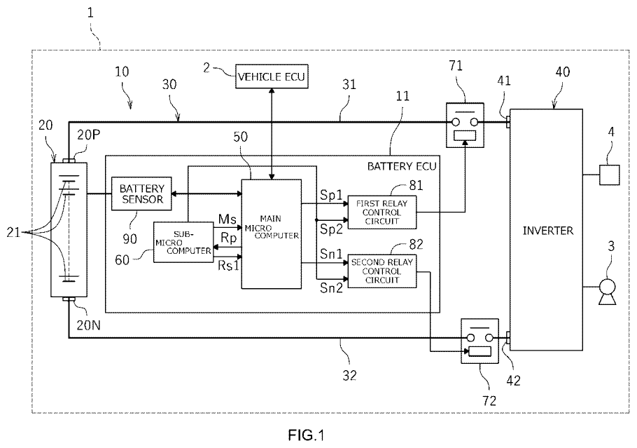

FIG. 1 is a block diagram of a battery control system 10 according to one preferred embodiment. As illustrated in FIG. 1, the battery control system 10 according to this preferred embodiment includes a battery 20, a charging/discharging circuit 30, an inverter 40, a first relay 71 and a second relay 72 located in the charging/discharging circuit 30, and a battery electronic control unit (ECU) 11. The battery ECU 11 includes a main microcomputer 50, a sub-microcomputer 60, a first relay control circuit 81, a second relay control circuit 82, and a battery sensor 90. The battery control system 10 is mounted on an electric vehicle 1.

In this preferred embodiment, the electric vehicle 1 includes a vehicle using electric power as an energy source, such as an electric automobile, a hybrid vehicle, and a plug-in hybrid vehicle. The electric vehicle 1 may be a four-wheeled vehicle or a two-wheeled vehicle. As illustrated in FIG. 1, in this preferred embodiment, the electric vehicle 1 includes a vehicle ECU 2 that controls an electric system of the electric vehicle 1, a driving motor 3, and a generator 4.

In this preferred embodiment, the battery 20 includes a plurality of electricity storage devices 21. The term “electricity storage device” herein refers to a general device from which electric energy can be extracted, and is a concept including a chemical battery such as a lithium ion secondary battery or a nickel-metal hydride battery and a physical battery such as an electric double layer capacitor. The electricity storage devices 21 are, for example, lithium ion secondary batteries. In this preferred embodiment, the electricity storage devices 21 are connected in series and constitute a battery stack. The battery 20 may include a battery pack in which a plurality of battery stacks are connected in parallel. It should be noted that the number of the electricity storage devices 21 included in the battery 20 may be one.

The charging/discharging circuit 30 connects the battery 20 and the electric vehicle 1 to each other. Specifically, the charging/discharging circuit 30 is connected to the driving motor 3 and the generator 4 of the electric vehicle 1 via the inverter 40. The charging/discharging circuit 30 includes a positive electrode-side path 31 connecting a positive electrode 20P of the battery 20 to a positive electrode-side terminal 41 of the inverter 40, and a negative electrode-side path 32 connecting a negative electrode 20N of the battery 20 to a negative electrode-side terminal 42 of the inverter 40.

The main microcomputer 50 computes the state of the battery 20 to transmit the calculation result to the vehicle ECU 2, and manages the state of the battery 20. The main microcomputer 50 is an example of a controller that controls the battery 20 of the electric vehicle 1. The main microcomputer 50 includes a microcomputer. At least a main portion of the main microcomputer 50 is a microcomputer. The microcomputer may include, for example, an interface (I/F) that receives data or others from an external device, a central processing unit (CPU) that executes an instruction of a program, a read only memory (ROM) that stores a program to be executed by the CPU, a random access memory (RAM) that is used as a working area in which the program is developed, and a memory device such as a memory that stores the program and various types of data. Signals transmitted from the main microcomputer 50 to other members in the battery control system 10 and signals received by the main microcomputer 50 from other members in the battery control system 10 will be described later.

The sub-microcomputer 60 monitors whether or not an abnormality occurs in the main microcomputer 50. The sub-microcomputer 60 is an example of a first monitor that monitors the main microcomputer 50. The sub-microcomputer 60 is communicably connected to the main microcomputer 50. The sub-microcomputer 60 includes a microcomputer. At least a main portion of the sub-microcomputer 60 is a microcomputer. It should be noted that the first monitor that monitors the controller does not necessarily include a microcomputer. For example, the first monitor may be an analog circuit. As illustrated in FIG. 1, in this preferred embodiment, the sub-microcomputer 60 transmits, to the main microcomputer 50, a message Ms instructing the main microcomputer 50 to return a computation result for an input. An example of contents of computation will be described later. In this preferred embodiment, the sub-microcomputer 60 constantly transmits the message Ms at predetermined time intervals. The main microcomputer 50 is set to return a computation result for an input, to the sub-microcomputer 60 (this response is indicated by reference character Rp in FIG. 1). The sub-microcomputer 60 determines whether the computation result returned from the main microcomputer 50 is correct or not. Operation of the battery control system 10 in response to the determination result of correctness will be described later.

The first relay 71 and the second relay 72 are located in the charging/discharging circuit 30, and capable of connecting or disconnecting the charging/discharging circuit 30. The first relay 71 and the second relay 72 are an example of contacts located in the charging/discharging circuit 30 and capable of connecting or disconnecting the charging/discharging circuit 30. The first relay 71 is located in the positive electrode-side path 31 of the charging/discharging circuit 30, and capable of connecting or disconnecting the positive electrode-side path 31. The second relay 72 is located in the negative electrode-side path 32 of the charging/discharging circuit 30, and capable of connecting or disconnecting the negative electrode-side path 32.

The charging/discharging circuit 30 is connected when the positive electrode-side path 31 is connected by the first relay 71 and the negative electrode-side path 32 is connected by the second relay 72. The charging/discharging circuit 30 is disconnected when at least one of disconnection of the positive electrode-side path 31 by the first relay 71 and disconnection of the negative electrode-side path 32 by the second relay 72 is performed. Although the first relay 71 and the second relay 72 operate in synchronization with each other, the charging/discharging circuit 30 includes the first relay 71 and the second relay 72 so that the charging/discharging circuit 30 can be disconnected even when one of the first relay 71 and the second relay 72 fails. However, a contact capable of connecting or disconnecting the charging/discharging circuit 30 may include only one relay.

The first relay control circuit 81 receives control signals from the main microcomputer 50 and the sub-microcomputer 60 to control opening/closing operation of the first relay 71. The second relay control circuit 82 receives control signals from the main microcomputer 50 and the sub-microcomputer 60 to control opening/closing operation of the second relay 72.

As illustrated in FIG. 1, the main microcomputer 50 transmits connection signals Sp1 and Sn1 to the first relay control circuit 81 and the second relay control circuit 82, respectively. In performing charging/discharging of the battery 20, the main microcomputer 50 transmits the connection signal Sp1 to the first relay control circuit 81, and transmits the connection signal Sn1 to the second relay control circuit 82. This connects the charging/discharging circuit 30 to the inverter 40. In performing no charging/discharging of the battery 20, the main microcomputer 50 stops the connection signals Sp1 and Sn1. Accordingly, the charging/discharging circuit 30 is disconnected.

Although conditions will be described later, the sub-microcomputer 60 is also configured to transmit a connection signal Sp2 to the first relay control circuit 81 and transmit a connection signal Sn2 to the second relay control circuit 82.

The battery sensor 90 measures the temperature and voltage of the battery 20 and a current flowing in the battery 20. The battery sensor 90 includes a temperature sensor, a voltmeter, and an ammeter. The battery sensor 90 transmits measurement results of the temperature, voltage, and current of the battery 20, to the main microcomputer 50.

### Monitoring of Main Microcomputer by Sub-microcomputer

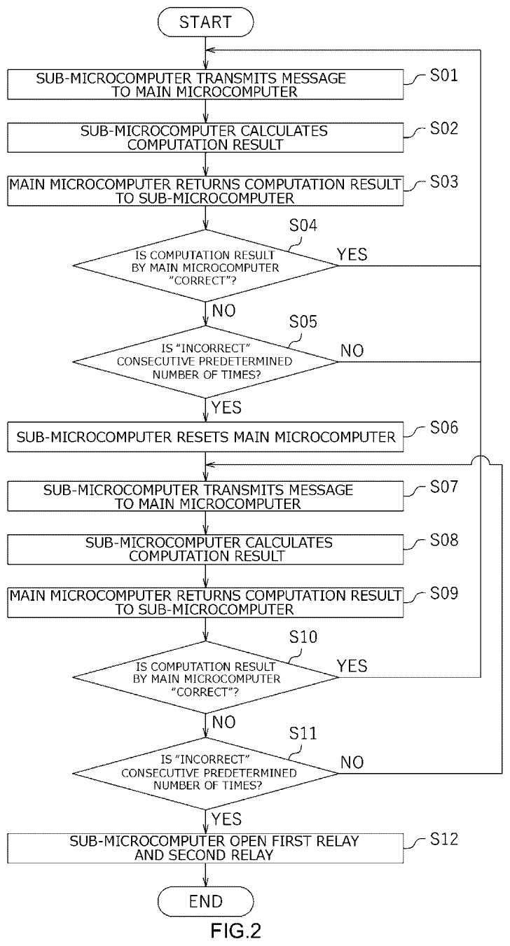

Monitoring of the main microcomputer 50 by the sub-microcomputer 60 will be described hereinafter. FIG. 2 is a flowchart showing a monitoring flow of the main microcomputer 50 by the sub-microcomputer 60. As shown in FIG. 2, in step S01 of the monitoring flow, the sub-microcomputer 60 transmits, to the main microcomputer 50, a message Ms instructing the main microcomputer 50 to return a computation result for an input (see FIG. 1). This input and computation are not particularly limited, and, for example, the sub-microcomputer 60 transmits a randomly selected integer, as an input to the main microcomputer 50. The computation result is a calculation result obtained by inputting this selected integer to a predetermined mathematical expression, for example. By randomly selecting an integer to be input, a numerical value input to the main microcomputer 50 basically varies for each computation. As a result, the computation result also varies for each computation. The sub-microcomputer 60 transmits, as an input to the main microcomputer 50, an 8-bit random number (an integer randomly selected from 0 to 253), for example. The predetermined mathematical expression is, for example, a four-arithmetic operation using an input as a variable.

The input to the main microcomputer 50 is not limited to a randomly selected integer, but in transmitting an instruction to the main microcomputer 50, the sub-microcomputer 60 preferably transmits an instruction including at least an input different from a previous input. For example, if the randomly selected integer is accidentally the same as the previous integer, the sub-microcomputer 60 may reselect an integer to be input to the main microcomputer 50. Alternatively, the sub-microcomputer 60 may randomly select an integer from an integer group excluding the previously selected integer. The method of selecting a numerical value to be input and the mathematical expression for the computation result are not particularly limited. Numerical values selectable as an input are not limited to integers, and may include, for example, fractional portions. The number of types of numerical values to be input is not limited to one, and may be two or more. In this case, the mathematical expression may include a plurality of variables.

In step S02, the sub-microcomputer 60 calculates a computation result by inputting the integer selected in step S01 to a mathematical expression. In step S03, the main microcomputer 50 transmits the computation result obtained by inputting the input integer (integer selected in step S01) to the mathematical expression, to the sub-microcomputer 60 (response Rp in FIG. 1). The mathematical expression described above is registered in advance in the main microcomputer 50 and the sub-microcomputer 60. In step S04, the sub-microcomputer 60 determines whether the computation result by the main microcomputer 50 and the computation result by the sub-microcomputer 60 coincide with each other or not (whether the computation result by the main microcomputer 50 is correct or not). If these computation results coincide with each other (YES in step S04), the sub-microcomputer 60 determines that the main microcomputer 50 is normal. In this case, the flow returns to step S01. Thereafter, steps S01 to S04 are repeated.

If the computation result by the main microcomputer 50 and the computation result by the sub-microcomputer 60 do not coincide with each other (NO in step S04, including a case where no computation result is returned), the sub-microcomputer 60 determines that the computation result by the main microcomputer 50 is incorrect and the main microcomputer 50 is abnormal. In this case, in subsequent step S05, the sub-microcomputer 60 determines whether the result that the computation result by the main microcomputer 50 is incorrect has been consecutively obtained a predetermined number of times or not. If the number of times of consecutive occurrence of the computation result “incorrect” does not reach the predetermined number (NO in step S05), the flow returns to step S01. This control is based on a design concept of awaiting for recovery from short-time abnormality of the main microcomputer 50 caused by electromagnetic noise or the like. If the number of times of consecutive occurrence of the computation result “incorrect” reaches the predetermined number (YES in step S05), in subsequent step S06, the sub-microcomputer 60 resets the main microcomputer 50 (a reset instruction signal is indicated by reference character Rs1 in FIG. 1). The main microcomputer 50 may return to normal by reset.

In next step S07, in a manner similar to step S01, the sub-microcomputer 60 transmits, to the main microcomputer 50, a message Ms instructing the main microcomputer 50 to return a computation result for an input. In step S08, in a manner similar to step S02, the sub-microcomputer 60 inputs an integer selected in step S07 to a mathematical expression and calculates a computation result. In step S09, in a manner similar to step S03, the main microcomputer 50 transmits the computation result obtained by inputting the input integer (integer selected in step S07) to the mathematical expression, to the sub-microcomputer 60. In step S10, in a manner similar to step S04, the sub-microcomputer 60 determines whether the computation result by the main microcomputer 50 and the computation result by the sub-microcomputer 60 coincide with each other or not (whether computation result by the main microcomputer 50 is correct or not). If these computation results coincide with each other (YES in step S09), the sub-microcomputer 60 determines that the main microcomputer 50 has returned to normal by reset. In this case, the flow returns to step S01.

If the computation result by the main microcomputer 50 and the computation result by the sub-microcomputer 60 do not coincide with each other (NO in step S10, including a case where no computation result is returned), the sub-microcomputer 60 determines that abnormality of the main microcomputer 50 continues. In this case, in subsequent step S11, the sub-microcomputer 60 determines whether the result that the computation result by the main microcomputer 50 is incorrect has been consecutively obtained a predetermined number of times or not. This predetermined number of times may be the same as or may be different from the predetermined number of times in step S05. The predetermined number of times in step S11 is set such that the time obtained by multiplying a period (time interval) of determination in steps S07 to S10 by the predetermined number of times (or the number of times obtained by subtracting one from the predetermined number of times) is longer than a time estimated to be required for resetting the main microcomputer 50. That is, the setting of the number of times of determination in step S11 is to avoid determination of the state of the main microcomputer 50 before reset of the main microcomputer 50 is completed. In step S11, if the number of times of consecutive occurrence of the computation result “incorrect” does not reach a predetermined number of times (NO in step S11), the flow returns to step S07.

In step S11, if the number of times of consecutive occurrence of the computation result “incorrect” reaches the predetermined number (YES in step S11), the sub-microcomputer 60 determines that the main microcomputer 50 fails. In this case, in the following step S12, the sub-microcomputer 60 instructs the first relay control circuit 81 and the second relay control circuit 82 to open the first relay 71 and the second relay 72, thereby disconnecting the charging/discharging circuit 30. In step S12, the sub-microcomputer 60 stops transmission of the connection signal Sp2 to the first relay control circuit 81 and transmission of the connection signal Sn2 to the second relay control circuit 82.

### Effects of Embodiment

The following description is directed to advantageous effects obtained by the battery control system 10 according to this preferred embodiment.

The battery control system 10 for the electric vehicle 1 according to this preferred embodiment includes: the main microcomputer 50 that controls the battery 20 of the electric vehicle 1; and the sub-microcomputer 60 that transmits, to the main microcomputer 50, the message Ms instructing the main microcomputer 50 to return a computation result for an input. The main microcomputer 50 is set to return the computation result for the input, to the sub-microcomputer 60. The sub-microcomputer 60 determines whether the returned computation result is correct or not. In the battery control system 10, from a result that the computation result returned from the main microcomputer 50 to the sub-microcomputer 60 is incorrect, it is detected that the main microcomputer 50 is in an abnormal state. Thus, the battery control system 10 can more reliably detect abnormality of the main microcomputer 50.

For example, if the abnormality of the main microcomputer 50 is determined based on whether the main microcomputer 50 is transmitting a signal or responding, abnormalities other than those related to the signal transmission or response of the main microcomputer 50 might not be detected. In comparison, by determining correctness of computation performed by the main microcomputer 50, as in the battery control system 10 according to this preferred embodiment, the abnormality of the main microcomputer 50, more specifically, the abnormality of the computation function, can be more reliably detected.

In this preferred embodiment, the sub-microcomputer 60 as the first monitor includes a microcomputer. In this configuration, the use of the microcomputer as the first monitor makes it easy to transmit the message Ms to the main microcomputer 50 and determine correctness of response from the main microcomputer 50. The use of the microcomputer as the first monitor can further reduce variations in a response time of the monitor circuit itself, compared to a configuration in which the first monitor is an analog circuit.

In this preferred embodiment, if the computation result is incorrect consecutively a predetermined number of times, the sub-microcomputer 60 resets the main microcomputer 50. In this configuration, in the case of temporary abnormality of the main microcomputer 50, the system awaits without resetting the main microcomputer 50. Accordingly, it is possible to avoid interruption of control of the main microcomputer 50 caused by reset, even though the abnormality will recover after being awaited. In addition, for abnormalities that continue for a certain period of time, these abnormalities can be addressed by resetting the main microcomputer 50.

The battery control system 10 according to this preferred embodiment further includes the charging/discharging circuit 30 that connects the battery 20 and the electric vehicle 1 to each other, and the first relay 71 and the second relay 72 located in the charging/discharging circuit 30 and capable of connecting or disconnecting the charging/discharging circuit 30. If the computation result is incorrect consecutively a predetermined number of times after reset of the main microcomputer 50, the sub-microcomputer 60 disconnects the first relay 71 and the second relay 72. In this configuration, if the computation result is still incorrect consecutively a predetermined number of times even after resetting the main microcomputer 50, the charging/discharging circuit 30 is disconnected by an instruction of the sub-microcomputer 60, thereby stopping charging/discharging between the battery 20 and the electric vehicle 1.

In this preferred embodiment, the sub-microcomputer 60 transmits a randomly selected integer as an input to the main microcomputer 50. The main microcomputer 50 returns the computation result obtained by inputting the input integer to the previously registered mathematical expression, to the sub-microcomputer 60. In this configuration, the integer input to the main microcomputer 50 basically varies for each computation. Accordingly, a correct computation result basically also varies for each computation. If a configuration in which the same numerical value is input to the main microcomputer 50 for each computation is employed, there is a possibility that a malfunction mode in which the main microcomputer 50 continues to return the same computation result cannot be detected. However, if a different numerical value is input to the main microcomputer 50 for each computation, such a malfunction mode can also be detected. On the other hand, since the mathematical expression is predetermined, it is sufficient to store the mathematical expression in the main microcomputer 50 and the sub-microcomputer 60, and it is unnecessary to create the mathematical expression for each computation. However, the sub-microcomputer 60 may create a new mathematical expression that does not include variables for each computation and transmit the new mathematical expression to the main microcomputer 50.

The input included in the message Ms from the sub-microcomputer 60 to the main microcomputer 50 is preferably different from at least a previous input. By inputting a different numerical value (not necessarily an integer) to the main microcomputer 50 for each computation, it is possible to reliably detect the malfunction mode of the main microcomputer 50 that continues to return the same computation result.

### Other Preferred Embodiments

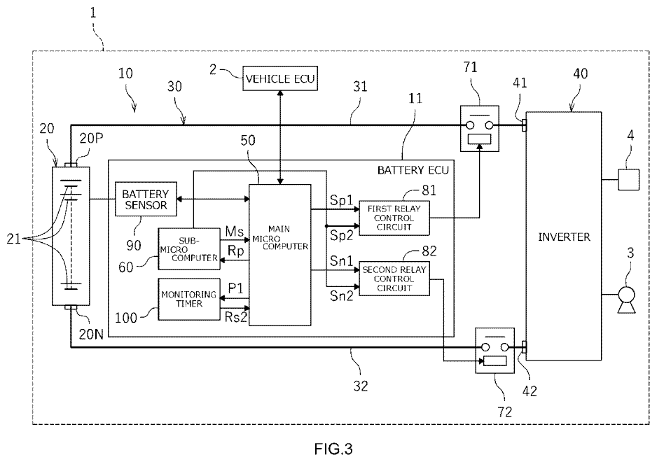

One preferred embodiment of the battery control system for the electric vehicle proposed here has been described above. The preferred embodiment described above, however, is merely an example, and the present disclosure can be carried out in other modes. FIG. 3 is a block diagram of a battery control system 10 according to another preferred embodiment. In the following description of this preferred embodiment, members having the same functions as those of the preferred embodiment described above are denoted by the same reference characters. Description for the same members and parts will not be repeated or will be simplified as appropriate.

As illustrated in FIG. 3, the battery control system 10 according to this preferred embodiment includes a monitoring timer 100 as well as the battery 20, the charging/discharging circuit 30, the inverter 40, the main microcomputer 50, the sub-microcomputer 60, the first relay 71, the second relay 72, the first relay control circuit 81, the second relay control circuit 82, and the battery sensor 90. The monitoring timer 100 is an example of a second monitor connected to the main microcomputer 50. In this preferred embodiment, the main microcomputer 50 transmits a signal indicating a normal state to the monitoring timer 100. The signal indicating the normal state herein is a pulse P1 having a predetermined period. It should be noted that the signal indicating the normal state is not limited to the pulse P1, and may be, for example, a signal having a predetermined waveform. When the signal indicating the normal state becomes invalid (here, when the period of the pulse P1 deviates from a set value beyond a predetermined allowable range, typically, when the pulse P1 is not transmitted anymore), the monitoring timer 100 resets the main microcomputer 50 (the reset instruction signal is indicated by reference character Rs2 in FIG. 3). If the computation result by the main microcomputer 50 is incorrect consecutively a predetermined number of times, the sub-microcomputer 60 disconnects the first relay 71 and the second relay 72. The predetermined number of times is set such that a time required for determining the computation result the predetermined number of times is longer than a time required for resetting the main microcomputer 50. Specifically, the predetermined number of times is set such that the time obtained by multiplying the period (time interval) of the computation result determination by the predetermined number of times (or the number of times obtained by subtracting one from the predetermined number of times) is longer than a time estimated to be required for resetting the main microcomputer 50.

According to this control, if the main microcomputer 50 returns to the normal state by reset, the charging/discharging circuit 30 is not disconnected, and returns to normal control by the main microcomputer 50. If the main microcomputer 50 does not return to the normal state by reset, the charging/discharging circuit 30 is disconnected after determination of the computation results a predetermined number of times.

It is assumed that when the main microcomputer 50 becomes an abnormal state, the computation result becomes incorrect and, at the same time, the pulse P1 also becomes invalid. In the configuration in which the monitoring timer 100 resets the main microcomputer 50 based on the fact that the pulse P1 becomes invalid, the reset of the main microcomputer 50 can be performed immediately when the main microcomputer 50 enters an abnormal state. Further, since whether to disconnect the charging/discharging circuit 30 is determined after resetting the main microcomputer 50, the battery 20 can continue to be connected to the electric vehicle 1 during that time. When the main microcomputer 50 returns to the normal state by reset, the battery 20 can continue to be connected to the electric vehicle 1. This control can prevent unnecessary disconnection of the charging/discharging circuit 30, thereby preventing unnecessary changes of the state of the electric vehicle 1.

In the preferred embodiment described above, the sub-microcomputer 60 monitors abnormality of the main microcomputer 50. Alternatively, in addition to this configuration, the main microcomputer 50 may also monitor abnormality of the sub-microcomputer 60. For example, abnormality of the sub-microcomputer 60 can be detected from the fact that the time interval for transmitting the message Ms is different from the setting, or that the content of the message Ms is strange (e.g., an integer is not transmitted, or the same input is consecutively transmitted, etc.).

The main microcomputer 50 and the sub-microcomputer 60 include separate microcomputers in the preferred embodiment described above, but may also use different arithmetic circuits (cores) of a single microcomputer. In this case, the microcomputer may be a microcomputer including a plurality of cores capable of performing computation processes independently of each other.

The preferred embodiment described above does not limit to the present disclosure unless otherwise specified. The technique disclosed here can be modified in various ways. Each component and each process mentioned here may be omitted as appropriate or combined as appropriate as long as no particular problems occur. The specification includes the disclosures described in the following items.

### Item 1:

A battery control system for an electric vehicle, battery control system comprising:
a controller that controls a battery of the electric vehicle; and
a first monitor that transmits, to the controller, a message instructing the controller to return a computation result for an input, wherein
the controller returns, to the first monitor, the computation result for the input, and
the first monitor determines whether the returned computation result is correct or not.

### Item 2:

The battery control system according to Item 1, wherein the first monitor includes a microcomputer.

### Item 3:

The battery control system according to Item 1 or 2, wherein the first monitor resets the controller if the computation result is incorrect consecutively a predetermined number of times.

### Item 4:

The battery control system according to Item 3, further comprising:
a charging/discharging circuit that connects the battery to the electric vehicle; and
a contact located in the charging/discharging circuit and capable of connecting or disconnecting the charging/discharging circuit, wherein
the first monitor disconnects the contact if the computation result is incorrect consecutively a predetermined number of times after reset of the controller.

### Item 5:

The battery control system according to any one of Items 1 to 4 wherein
the first monitor transmits a randomly selected integer as the input to the controller, and
the controller returns, to the first monitor, a computation result obtained by inputting the input integer to a previously registered mathematical expression.

### Item 6:

The battery control system according to any one of Items 1 to 5, wherein the input included in the message is different from at least a previous input.

### Item 7:

The battery control system according to any one of Items 1 to 6, further comprising:
a charging/discharging circuit that connects the battery to the electric vehicle;
a contact located in the charging/discharging circuit and capable of connecting or disconnecting the charging/discharging circuit; and
a second monitor connected to the controller, wherein
the controller transmits a signal indicating a normal state to the second monitor,
the second monitor resets the controller if the signal indicating the normal state is invalid,
the first monitor disconnects the contact if the computation result is incorrect consecutively a predetermined number of times, and
the predetermined number of times is set such that a time required for determining the computation result the predetermined number of times is longer than a time required for resetting the controller.

What is claimed is:

1. A battery control system for an electric vehicle, battery control system comprising:
a controller that controls a battery of the electric vehicle; and
a first monitor that transmits, to the controller, a message instructing the controller to return a computation result for an input, wherein
the controller returns, to the first monitor, the computation result for the input, and
the first monitor determines whether the returned computation result is correct or not.

2. The battery control system according to claim 1, wherein the first monitor includes a microcomputer.

3. The battery control system according to claim 1, wherein the first monitor resets the controller if the computation result is incorrect consecutively a predetermined number of times.

4. The battery control system according to claim 3, further comprising:
a charging/discharging circuit that connects the battery to the electric vehicle; and
a contact located in the charging/discharging circuit and capable of connecting or disconnecting the charging/discharging circuit, wherein
the first monitor disconnects the contact if the computation result is incorrect consecutively a predetermined number of times after reset of the controller.

5. The battery control system according to claim 1, wherein
the first monitor transmits a randomly selected integer as the input to the controller, and
the controller returns, to the first monitor, a computation result obtained by inputting the input integer to a previously registered mathematical expression.

6. The battery control system according to claim 1, wherein the input included in the message is different from at least a previous input.

7. The battery control system according to claim 1, further comprising:
a charging/discharging circuit that connects the battery to the electric vehicle;
a contact located in the charging/discharging circuit and capable of connecting or disconnecting the charging/discharging circuit; and
a second monitor connected to the controller, wherein
the controller transmits a signal indicating a normal state to the second monitor,
the second monitor resets the controller if the signal indicating the normal state is invalid,
the first monitor disconnects the contact if the computation result is incorrect consecutively a predetermined number of times, and
the predetermined number of times is set such that a time required for determining the computation result the predetermined number of times is longer than a time required for resetting the controller.
